(19) United States
(12) Patent Application Publication
(10) Pub. No.: US 2023/0075718 A1
(43) Pub. Date: Mar. 9, 2023

(54) METHOD FOR PREPARING NANOSHEET DISPERSION SOLUTION CONTAINING TWO-DIMENSIONAL MATERIAL WITH SEPARATED LAYERED STRUCTURE

(71) Applicant: POSTECH Research and Business Development Foundation, Pohang-si (KR)

(72) Inventors: Yong Young NOH, Pohang-si (KR); Hyunjun Kim, Pohang-si (KR)

(21) Appl. No.: 17/863,544

(22) Filed: Jul. 13, 2022

(30) Foreign Application Priority Data
Sep. 7, 2021 (KR) 10-2021-0118992

(51) Int. Cl. C09D 11/52; C08K 3/04

(52) U.S. Cl. CPC C09D 11/52; C08K 3/042; B82Y 30/00

(57) ABSTRACT

A method for preparing a nanosheet dispersion solution includes a step of adding a two-dimensional material having a layered structure to a solvent containing at least two materials to weaken an interlayer bonding force, and a step in which a nanosheet, which is exfoliated as the material is attached to a surface thereof by a covalent bond during the exfoliation process, has a repulsive force so as not to agglomerate.

The nanosheet dispersion solution prepared by the preparing method of the inventive concept may be obtained by increasing the surface area of the two-dimensional sheet from the two-dimensional material, may solve the problem of the yield, may reduce a barrier in the charge transfer by reducing the interlayer distance, and may maintain the dispersed phase of the ink prepared by the repulsive force of the nanosheet.

### CROSS-REFERENCE TO RELATED APPLICATIONS

A claim for priority under 35 U.S.C. § 119 is made to Korean Patent Application No. 10-2021-0118992 filed on Sep. 7, 2021, in the Korean Intellectual Property Office, the entire contents of which are hereby incorporated by reference.

### BACKGROUND

Embodiments of the inventive concept described herein relate to a method for preparing a nanosheet dispersion solution containing a two-dimensional material with a separated layered structure.

A lot of research has been done on a two-dimensional material because of excellent chemical, optical, and electrical performances thereof. In particular, the two-dimensional material is distinguished from other materials in that a van der Waals force acting between layers enables exfoliation of the layers into single layers. In Chemical Formula MX₂, M is a transition metal such as Mo, W, and Ta, and X is a chalcogen such as S, Se, Te, or the like. In particular, for the two-dimensional van der Waals materials, a band gap varies based on the number of layers. This suggests that a technology capable of adjusting the number of layers of the two-dimensional material may influence excellent properties in practical engineering application.

As a method for separating the layers of the two-dimensional material stacked on top of each other, a solution phase exfoliation method is used as the easiest method. This is a method of immersing the two-dimensional material in a solvent into which an ionic material is added, then applying a DC power supply to intercalate ions between the layers to weaken the van der Waals force between the layers to widen an interlayer distance, and then using an ultrasonic wave to separate the layers from each other. Through such method, a very thin two-dimensional nanosheet dispersion solution (ink) composed of one to four layers is prepared. In the preparation of the ink, to maintain a dispersed phase of the dispersion solution, a polymer such as polyvinylpyrrolidone (PVP) is attached to a surface of the nanosheet to maintain interlayer repulsion.

Such two-dimensional material ink may be coated on a substrate as a thin film, and may be applied to various devices because of flexibility and thinness. The two-dimensional material ink is widely used in a photodiode, an active layer of a thin film transistor, and the like because of excellent electrical properties thereof. However, there are representative disadvantages, such as a surface area of the nanosheet limited by the use of the ions, a low yield, and a great thickness compared to that of a mechanical exfoliation method, that overshadow the numerous advantages of the solution process. Therefore, there is a need for a technology that has a large surface area and a high yield and is able to more precisely control the interlayer distance.

### SUMMARY

Embodiments of the inventive concept provide a method for preparing a nanosheet dispersion solution, the method including adding a two-dimensional material having a layered structure to a solution containing an ionic material to reduce an interlayer bonding force,

forming a covalent bond on a surface of the two-dimensional material as radicals enter gaps between the layers, and

preparing the nanosheet dispersion solution with two-dimensional nanosheets having a layered structure separated into at least one layer dispersed with mutual repulsion because of the radicals bound to surfaces of the two-dimensional nanosheets.

In addition, embodiments of the inventive concept provide a method for preparing a nanosheet dispersion solution, the method including

a step 1) of adding a two-dimensional material having a layered structure into a solution containing an ionic material and a radical generating material to form a mixture;
a step 2) of applying a voltage to the mixture of the step 1); and
a step 3) of applying an ultrasonic wave to the result of the step 2).

In addition, embodiments of the inventive concept provide

a nanosheet dispersion solution prepared by the preparing method described above.

In one example, the technical problems to be solved in the inventive concept are not limited to the technical problems mentioned above, and another technical problem not mentioned will be clearly understood by those of ordinary skill in the art to which the inventive concept belongs from the following description.

According to an exemplary embodiment, a method for preparing a nanosheet dispersion solution includes

adding a two-dimensional material having a layered structure to a solution containing an ionic material to reduce an interlayer bonding force,

forming a covalent bond on a surface of the two-dimensional material as radicals enter gaps between the layers, and

preparing the nanosheet dispersion solution with two-dimensional nanosheets having a layered structure separated into at least one layer dispersed with mutual repulsion because of the radicals bound to surfaces of the two-dimensional nanosheets.

A flowchart for easily understanding the preparing method is shown in FIG. 1. FIG. 1 is a flowchart illustrating a method for preparing a nanosheet dispersion solution according to an embodiment of the inventive concept.

First, referring to FIG. 1, the method for preparing the nanosheet dispersion solution of the inventive concept may include a step of reducing an interlayer bonding force (S10), a step of adsorption of radicals (S20), a step of forming a covalent bond (S30), a step of generating a repulsive force between sheets (S40), and a step of forming the nanosheet dispersion solution (S50).

In the step of reducing the interlayer bonding force (S10), a solution containing a two-dimensional material having a layered structure may be prepared, and cations may be added to the solution to adjust an interlayer spacing.

In this regard, the two-dimensional material, as a material with the layered structure in which layers with a very small thickness at a level of an atomic layer are coupled to each other by a van der Waals force, may include a material having a natural crystal structure or a synthetic two-dimensional material. For example, the two-dimensional material may be graphene or a transition metal dichalcogenide compound.

In this regard, the transition metal of the transition metal dichalcogenide may be Mo, W, and In, and the dichalcogen of the transition metal dichalcogenide may be S₂ or Se₂.

In this regard, the ionic material intercalated into the two-dimensional material may be intercalated between the layers of the two-dimensional material to reduce the acting van der Waals force, thereby increasing the interlayer spacing. The ionic material may be a cation having a size smaller than that of the interlayer spacing. For example, the ion may include a lithium ion (Lit), a tetraheptylammonium ion (THA⁺), a tetrabutylammonium ion (TBA⁺), and a tetrapentylammonium ion (TPA⁺).

However, the inventive concept is not limited to the above-described materials, and various materials are able to be used. As a basic principle, an intercalation material that may increase the interlayer spacing transfers electrons to a 2d van der Waals material. In this regard, a charge transfer complex is formed by bonding between the 2d van der Waals and the material intercalated between the layers, which have different charges, by the electron transfer. Therefore, the intercalation material is adsorbed on a surface of the 2d van der Waals nanosheet and intercalated between the layers of the two-dimensional material to reduce the acting bonding force (the van der Waals force), thereby being dispersed in a solvent as one to several layers of nanosheets.

In this regard, when an ionic material that forms the radicals is added, depending on a type and a concentration thereof, the interlayer spacing of the two-dimensional material may be adjusted, a yield may be increased, and a surface area of the exfoliated nanosheet may be increased. Therefore, the two-dimensional material may form the two-dimensional nanosheet having the layered structure of at least one layer (one layer to several layers).

In the step of the adsorption of radicals (S20), the radicals may be adsorbed on the surface of the two-dimensional nanosheet by applying the radicals to the solution of the two-dimensional material whose interlayer distance is widened by the ion.

In this regard, the radical generating material may be 4-nitrophenyl, 4-nitrobenzyldiazonium, or a combination thereof, and the material may be dissolved in the solution and nitrogen may be removed to generate the radicals.

In this regard, the radicals may be attached to a chalcogen element of the two-dimensional material and undergo the step of forming the covalent bond (S30). Thereafter, the repulsive force between the sheets is generated by the covalent bond formed (S40).

In addition, another embodiment for achieving the above object is provided below. The following embodiment is a different expression only for those skilled in the art to easily implement the preparing method. Terms defined the same or similar to those used in the preparing method are defined the same unless otherwise specified.

According to an exemplary embodiment, a method for preparing a nanosheet dispersion solution includes

a step 1) of adding a two-dimensional material having a layered structure into a solution containing an ionic material and a radical generating material to form a mixture,
a step 2) of applying a voltage to the mixture of the step 1), and
a step 3) of applying an ultrasonic wave to the result of the step 2).

In the inventive concept, the ionic material may be at least one selected from a group consisting of a lithium ion (Li⁺), a tetraheptylammonium ion (THA⁺), a tetrabutylammonium ion (TBA⁺), and a tetrapentylammonium ion (TPA⁺). In the inventive concept, the radical generating material may be 4-nitrophenyl, 4-nitrobenzyldiazonium, or a combination of the 4-nitrophenyl and the 4-nitrobenzyldiazonium.

In the inventive concept, the two-dimensional material may contain graphene or a transition metal dichalcogenide compound.

The transition metal of the transition metal dichalcogenide may be at least one selected from a group consisting of Mo, W, and In, and the dichalcogen of the transition metal dichalcogenide may be S₂, Se₂, or a combination of the S₂ and Se₂.

In this regard, the applied voltage may be in a range from 10 to 20 V, but the inventive concept may not be limited thereto, and a voltage appropriate for the layered sheet structure to be separated and the covalent bond to be generated may be applied.

The ionic material and the radical generating material may be contained in the solution in a molar ratio of 2 to 6:1. When the molar ratio of the ionic material and the radical generating material is out of the above range, because the spacing between the layers of the layered structure is not widened or penetration of the radicals is not easy, the exfoliation between the layers of the layered structure may not proceed as much as desired.

According to an exemplary embodiment, provided is a nanosheet dispersion solution prepared by the above preparing method.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a flowchart illustrating a method for preparing a nanosheet dispersion solution using a liquid crystal phase of a two-dimensional material according to an embodiment of the inventive concept;

FIG. 2A shows an atomic force microscope (AFM) image of an MoS₂ nanosheet prepared by applying THA⁺ in the inventive concept, FIG. 2B is a graph showing a height profile of a cross-section A-A′ in FIG. 2A, FIG. 2C is a graph showing a size distribution of the MoS₂ nanosheet prepared by applying the THA⁺ in the inventive concept;

FIG. 3A shows an atomic force microscope (AFM) image of an MoS₂ nanosheet prepared by applying TBA⁺ in the inventive concept, FIG. 3B is a graph showing a height profile of a cross-section B-B′ in FIG. 3A, FIG. 3C is a graph showing a size distribution of the MoS₂ nanosheet prepared by applying the TBA⁺ in the inventive concept;

FIG. 4A shows an atomic force microscope (AFM) image of a MoS₂ nanosheet prepared by applying a THA⁺/4-NBD⁺ mixture in the inventive concept, FIG. 4B is a graph showing a height profile of a cross-section C—C′ in FIG. 4A, and FIG. 4C is a graph showing a size distribution of the MoS₂ nanosheet prepared by applying the THA⁺/4-NBD⁺ mixture in the inventive concept;

FIG. 5A shows a chemical composition analysis result of a MoS₂ nanosheet prepared by applying THA⁺ in the inventive concept, and FIG. 5B shows a chemical composition analysis result of a MoS₂ nanosheet prepared by applying a THA⁺/4-NBD⁺ mixture in the inventive concept;

FIG. 6A shows I-V curve transfer characteristics of a transistor fabricated with a MoS₂ nanosheet prepared by applying THA⁺ in the inventive concept, FIG. 6B shows I-V curve transfer characteristics of a transistor fabricated with a MoS₂ nanosheet prepared by applying TBA⁺ in the inventive concept, FIG. 6C shows I-V curve transfer characteristics of a transistor fabricated with a MoS₂ nanosheet prepared by applying a THA⁺/4-NBD⁺ mixture in the inventive concept,

FIG. 6D shows I-V curve transfer characteristics of a transistor fabricated with a 2 flakes of large sized exfoliated MoS₂ nanosheets prepared by intercalation of a THA⁺/4-NBD⁺ mixture in the inventive concept; and

FIG. 7 shows structural formulas of THA⁺, TBA⁺, and 4-NBD⁺ applied in the inventive concept.

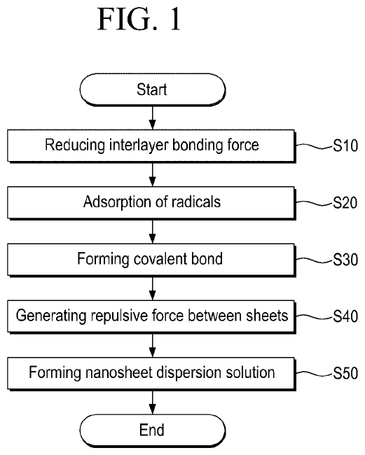

### DETAILED DESCRIPTION

Hereinafter, Examples of the inventive concept will be described in more detail with reference to the accompanying drawings. The Examples of the inventive concept may be modified in various forms, and the scope of the inventive concept should not be construed as being limited to the following Examples. The present Example is provided to more completely describe the inventive concept to those of ordinary skill in the art. Therefore, a shape of an element in the drawings is exaggerated to emphasize a clearer description.

### EXAMPLES

### Example 1. Method for Preparing Nanosheet Dispersion Solution Using Liquid Crystal Phase of Two-Dimensional Material

An electrochemical cell having two electrodes was prepared. A positive electrode of the electrochemical cell was a graphite core and a negative electrode was a copper plate to which MoS₂ was connected. As an electrolyte, an electrolyte aqueous solution in which 4-nitrobenzyldiazonium (4-NBD) and tetrahexylammonium bromide (THAB) are dissolved in 40 mL of acetonitrile (Sigma-Aldrich, anhydrous 99.8%) in a ratio of 1:4 was used.

Specifically, natural MoS₂ ore was attached to one end of the copper plate and connected to the negative electrode. The positive electrode was connected to the graphite core. Both of the electrodes were connected to alligator tongs and connected to a DC power supply at a voltage of 15 V. Both of the electrodes were immersed in the electrolyte aqueous solution in which the 4-NBD and the THAB are dissolved in the acetonitrile in the ratio of 1:4. Thereafter, DC power was connected for 1 hour until crystals were sufficiently swollen.

Thereafter, the generated crystals were added into 40 mL N,N-DMF (Sigma-Aldrich, anhydrous 99.8%) aqueous solution and dispersed for 30 minutes at a weak intensity after the aqueous solution was put into an ultrasonic wave washer. The dispersed solution was put into a centrifuge tube, and turned 3 times at 1000 rpm such that a precipitate is discarded and only an upper layer solution remains. After the upper layer solution was turned at 3000 rpm and a precipitate at 3000 rpm was discarded once more, isopropyl alcohol was added to a precipitate at 5000 rpm to prepare a final product.

### Example 2. Analysis of Physical Properties of Nanosheet

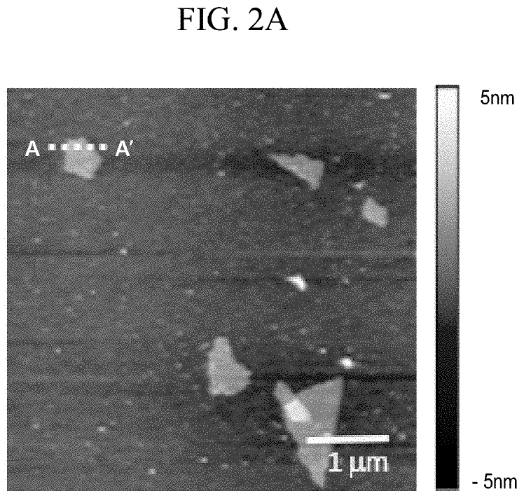

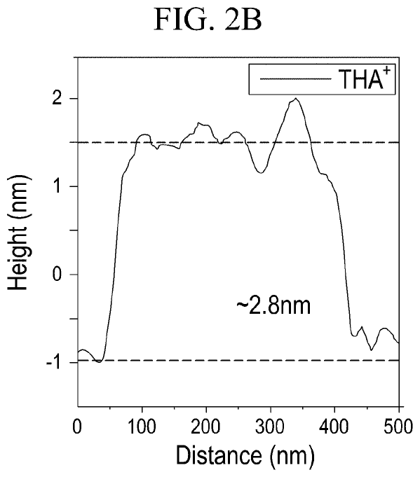

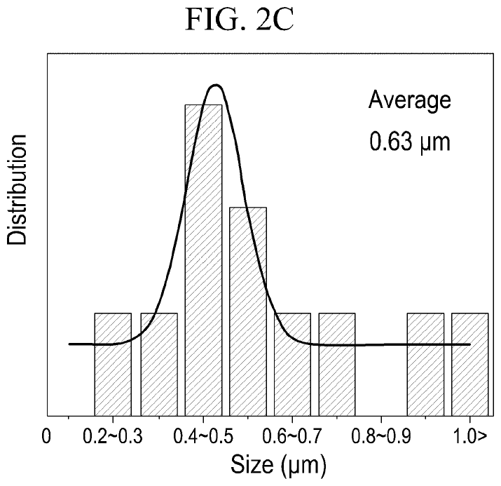

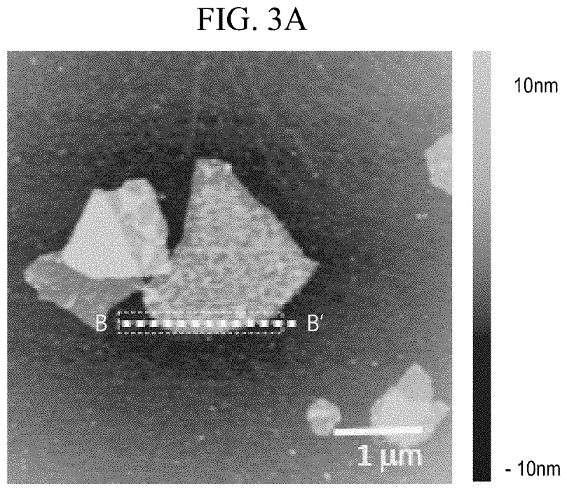

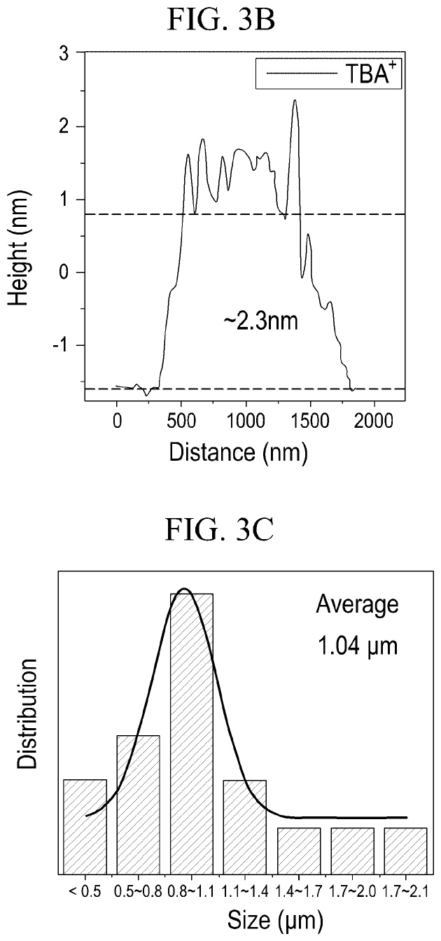

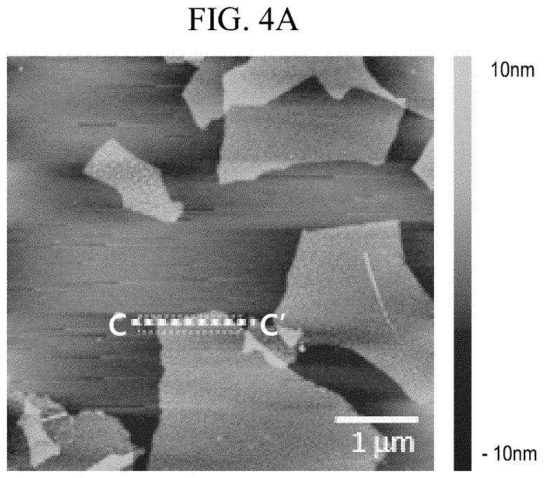

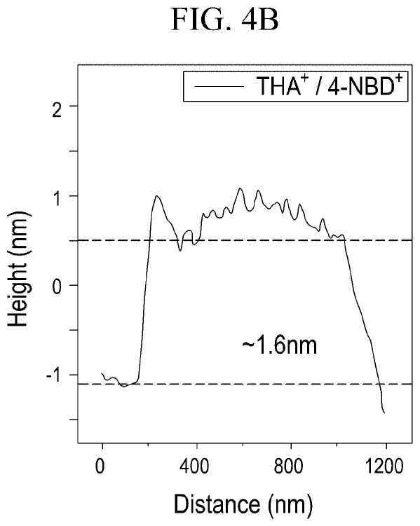

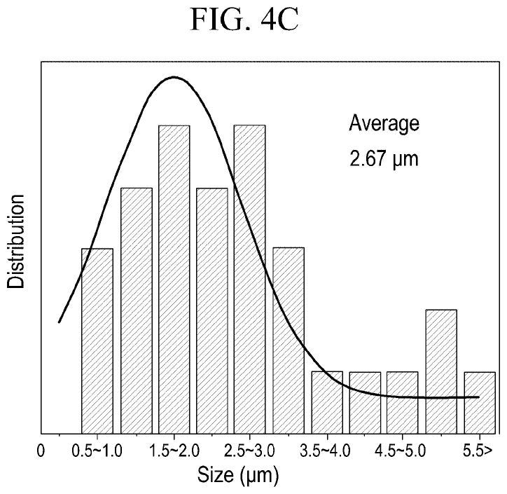

A thickness of one nanosheet was observed with an atomic force microscope, and results thereof are shown in in FIG. 2A, FIG. 2B, FIG. 2C, FIG. 3A, FIG. 3B, FIG. 3C, FIG. 4A, FIG. 4B, and FIG. 4C.

FIG. 2A shows an atomic force microscope (AFM) image of an MoS₂ nanosheet prepared by applying THA+ in the inventive concept, FIG. 2B is a graph showing a height profile of a cross-section A-A′ in FIG. 2A, FIG. 2C is a graph showing a size distribution of the MoS₂ nanosheet prepared by applying the THA⁺ in the inventive concept, FIG. 3A shows an atomic force microscope (AFM) image of an MoS₂ nanosheet prepared by applying TBA⁺ in the inventive concept, FIG. 3B is a graph showing a height profile of a cross-section B-B′ in FIG. 3A, FIG. 3C is a graph showing a size distribution of the MoS₂ nanosheet prepared by applying the TBA⁺ in the inventive concept, FIG. 4A shows an atomic force microscope (AFM) image of a MoS₂ nanosheet prepared by applying a THA⁺/4-NBD⁺ mixture in the inventive concept, FIG. 4B is a graph showing a height profile of a cross-section C-C′ in FIG. 4A, and FIG. 4C is a graph showing a size distribution of the MoS₂ nanosheet prepared by applying the THA⁺/4-NBD⁺ mixture in the inventive concept.

Lateral sizes of the exfoliated MoS₂ nanosheets were characterized by the atomic force microscope (AFM). From the AFM images, the lateral size of the exfoliated nanosheet was the largest in the Example in which the THA⁺/4-NBD⁺ mixture was intercalated, followed by the Examples in which the TBA⁺ and THA⁺ were respectively intercalated.

Average (range) lateral sizes of the exfoliated nanosheets were 2.67(0.58-9.51) μm, 1.04(0.79-10.12) μm, and 0.63(0.23-2.36) μm in the Examples in which the THA⁺/4-NBD⁺ mixture, the TBA⁺ and THA⁺ were inserted, respectively.

Although a size range of the MoS₂ nanosheets exfoliated using the intercalant is very wide, it was reported that the MoS₂ nanosheet obtained by the THA⁺ assisted exfoliation is generally smaller than that obtained by the TBA⁺ assisted exfoliation.

Similar results were identified based on the previous study that the average lateral size of the MoS₂ nanosheet exfoliated using the THA⁺ is smaller than that of the MoS₂ nanosheet exfoliated using the TBA⁺ as the intercalant.

In addition, the exfoliated nanosheet using the THA⁺/4-NBD⁺ mixture exhibits the largest average lateral size among the three intercalants used in the inventive concept, so that it may be identified that the THA⁺/4-NBD⁺ mixture is an effective intercalant for generating a large sized exfoliated MoS₂ nanosheet.

In addition, it was found that the exfoliated nanosheet is composed of one or several layers. When the above method was applied, it was identified that the thickness actually decreased from 3 nm to 2 nm, and at the same time, it was identified that a surface area increased from 2 μm² to 9 μm².

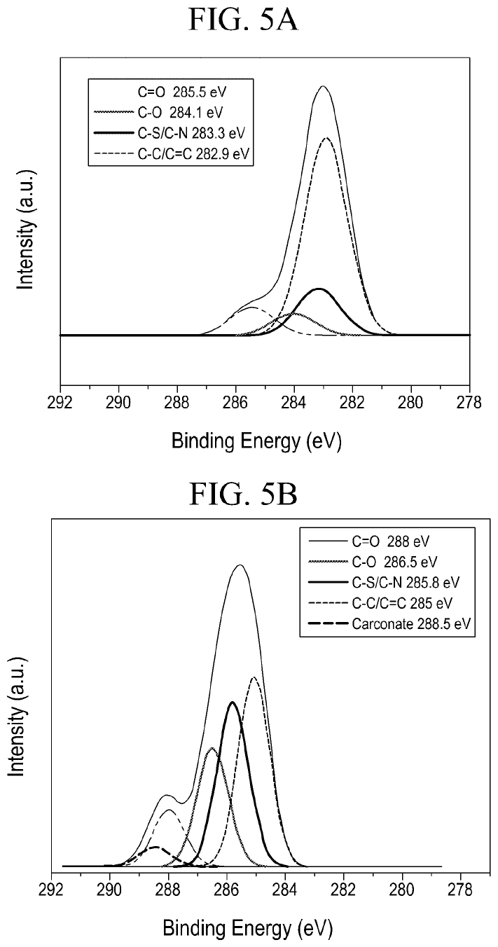

It was identified through photoemission spectroscopy (PES) that 4-NP is actually well attached to a surface of MoS₂ by a covalent bond, which is shown in FIG. 5A and FIG. 5B.

FIG. 5A shows a chemical composition analysis result of a MoS₂ nanosheet prepared by applying THA⁺ in the inventive concept, and FIG. 5B shows a chemical composition analysis result of a MoS₂ nanosheet prepared by applying a THA⁺/4-NBD⁺ mixture in the inventive concept.

In this regard, measurements were done at 300 K and 515 eV in Pohang Accelerator Laboratory 10D HRPES beam line. The chemical composition analysis was performed using a high-resolution XPS to obtain information on a chemical composition of the exfoliated MoS₂ nanosheet into which the THA⁺/4-NBD⁺ mixture was intercalated.

The XPS was performed on a Si substrate with dispersed ink containing the exfoliated MoS₂ nanosheet into which the THA⁺/4-NBD⁺ mixture was intercalated.

To identify interfacial bonds between the MoS₂ and carbon (C)-based chemicals, analysis of a C1s core level is important. In the inventive concept, a sharp C1s peak was found at 285.2 eV indicating a presence of C—C bonding, and weak peaks at 286.1 eV and 288.5 eV indicating a presence of C—S/C—N and C═O bonding in the exfoliated MoS₂ nanosheet into which the THA⁺ was intercalated were found.

In contrast, a C1s spectrum of the MoS₂ nanosheet into which the THA⁺/4-NBD⁺ mixture was intercalated had peaks at 285 eV and 285.9 eV indicating the presence of the C—C and C—S/C—N covalent bonding. In addition, weak peaks at 287 eV and 288.5 eV were demonstrated indicating C—O and C═O bonding, respectively.

An integrated area of the C—S/C—N bonding on the MoS₂ nanosheet into which the THA⁺/4-NBD⁺ mixture was intercalated was greater compared with that of the MoS₂ nanosheet into which the THA⁺ was intercalated, which indicates that a 4-Nitrophenyl (4-NP) ring is covalently grafted on a site of sulfur.

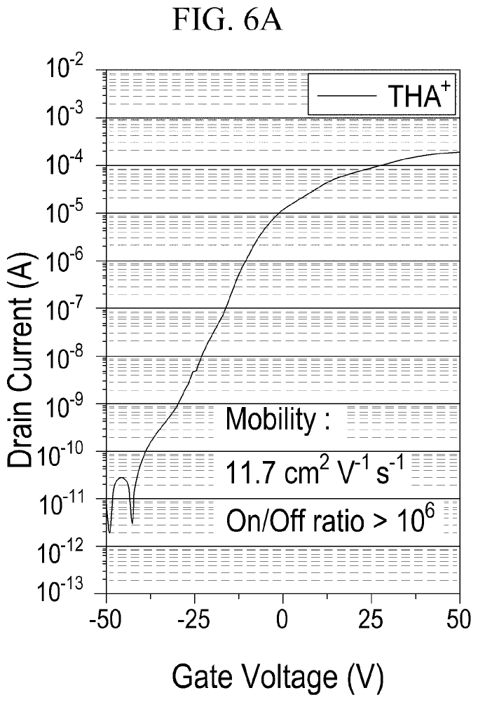

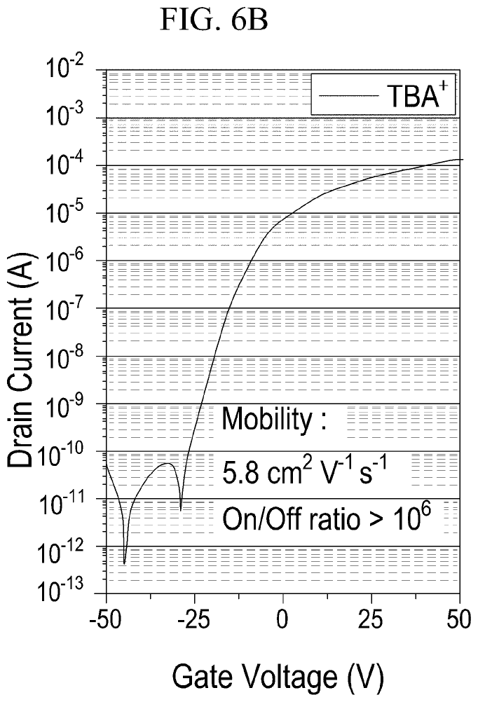

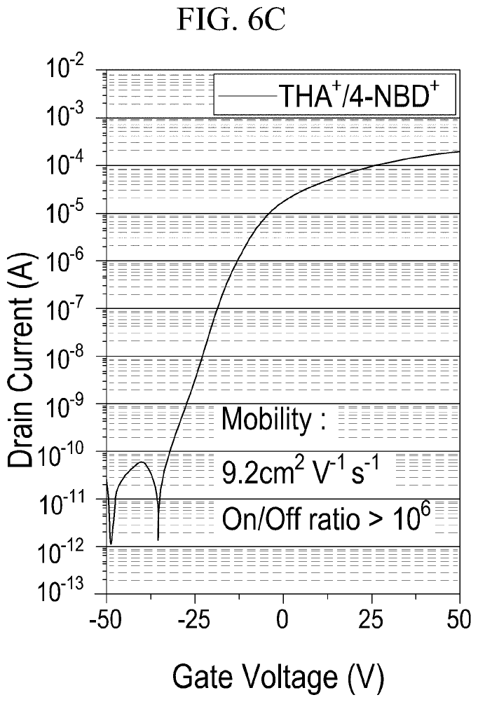

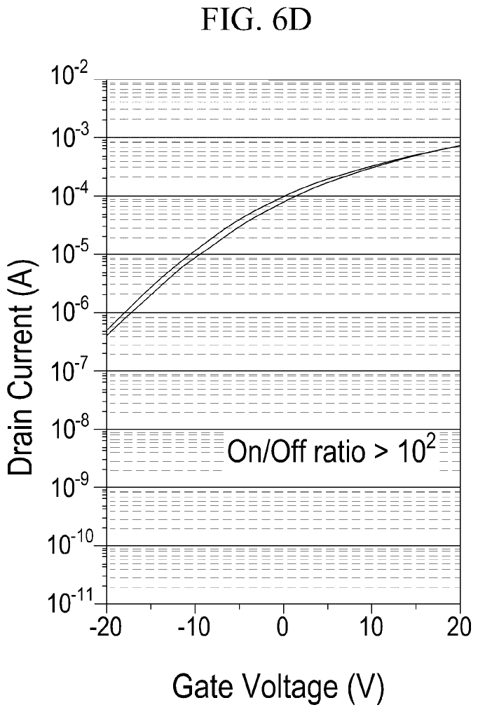

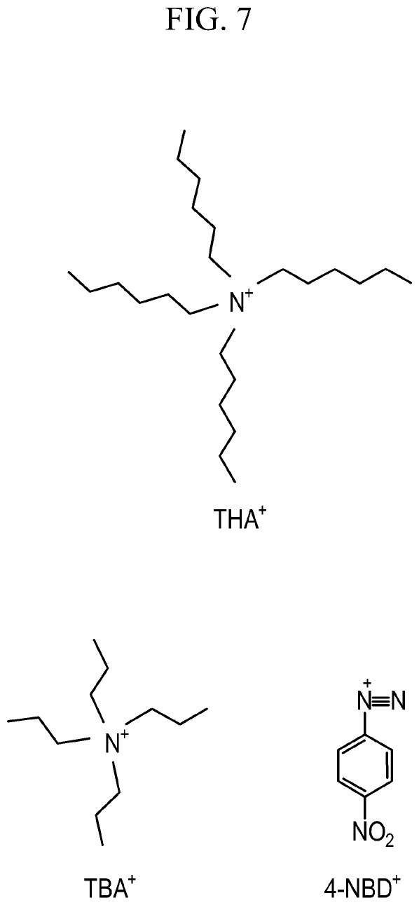

FIG. 6A shows I-V curve transfer characteristics of a transistor fabricated with a MoS₂ nanosheet prepared by applying THA⁺ in the inventive concept, FIG. 6B shows I-V curve transfer characteristics of a transistor fabricated with a MoS₂ nanosheet prepared by applying TBA⁺ in the inventive concept, FIG. 6C shows I-V curve transfer characteristics of a transistor fabricated with a MoS₂ nanosheet prepared by applying a THA⁺/4-NBD⁺ mixture in the inventive concept, FIG. 6D shows I-V curve transfer characteristics of a transistor fabricated with a 2 flakes of large sized exfoliated MoS₂ nanosheets prepared by intercalation of a THA⁺/4-NBD⁺ mixture in the inventive concept, and FIG. 7 shows structural formulas of THA⁺, TBA⁺, and 4-NBD⁺ applied in the inventive concept.

A 2D transistor was fabricated with the ink produced by the electrochemical exfoliation of the MoS₂ using the THA⁺/4-NBD⁺ mixture to determine whether this new technique may be applied to improving a performance of the transistor processed with the solution.

In a previous report, the THA⁺ assisted MoS₂ nanosheet device was shown to have an electron mobility of 10 cm²V⁻¹s⁻¹ with an on/off ratio of 10-5.28. In the inventive concept, the THA⁺ assisted MoS₂ nanosheet device showed the electron mobility of 11.7 cm²V⁻¹s⁻¹ and the on/off ratio of 106, which showed slightly better performance than the previously reported transistor.

In the TBA⁺ assisted MoS₂ nanosheet device had lower performance than the THA⁺ assisted device with the electron mobility of 5.8 cm²V⁻¹s⁻¹, and the on/off ratio of 106. For reference, the THA⁺/4-NBD⁺ assisted MoS₂ device had the mobility of 9.2 cm²V⁻¹s⁻¹ and the on/off ratio of 106, which was similar to the performance of previously reported THA⁺ assisted MoS₂ single flake device.

The transistor was fabricated using the 2 flakes of large sized exfoliated MoS₂ nanosheets produced by the intercalation of the THA⁺/4-NBD⁺ mixture. The electron on/off ratio was 102 in this device. In this regard, it was identified that the surface area of the nanosheet contained in the dispersion solution prepared based on the method for preparing the nanosheet dispersion solution using the liquid crystal phase of the MoS₂ two-dimensional material according to one embodiment of the inventive concept is increased, and the nanosheets are well dispersed in an ink phase because of the repulsive force.

The above detailed description exemplifies the inventive concept. In addition, the above-mentioned content is to describe a preferred embodiment of the inventive concept, and the inventive concept is able to be used in various other combinations, modifications, and environments. That is, changes or modifications are possible within the scope of the concept of the invention disclosed herein, the scope equivalent to the written disclosure, and/or within the scope of skill or knowledge in the art. The written embodiment is to describe the best state for implementing the technical idea of the inventive concept, and various changes thereof required in specific application fields and uses of the inventive concept are also possible. Therefore, the above detailed description of the invention is not intended to limit the inventive concept to the disclosed embodiment. The appended claims should also be construed to include other embodiments as well.

The nanosheet dispersion solution prepared by the preparing method of the inventive concept may be obtained by increasing the surface area of the two-dimensional sheet from the two-dimensional material, may solve the problem of the yield, may reduce a barrier in the charge transfer by reducing the interlayer distance, and may maintain the dispersed phase of the ink prepared by the repulsive force of the nanosheet.

In one example, the effects that may be obtained from the inventive concept are not limited to the above-mentioned effects, and other effects not mentioned will be clearly understood by those of ordinary skill in the art to which the inventive concept belongs from the following description.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for preparing a nanosheet dispersion solution, the method comprising:
adding a two-dimensional material having a layered structure to a solution containing an ionic material to reduce an interlayer bonding force;
forming a covalent bond on a surface of the two-dimensional material as radicals enter gaps between the layers; and
preparing the nanosheet dispersion solution with two-dimensional nanosheets having a layered structure separated into at least one layer dispersed with mutual repulsion because of the radicals bound to surfaces of the two-dimensional nanosheets.

2. The method of claim 1, wherein the reducing of the interlayer bonding force includes:
injecting the ionic material into the two-dimensional material having the layered structure to reduce the interlayer bonding force of the two-dimensional material.

3. The method of claim 1, wherein the forming of the covalent bond on the surface of the two-dimensional material includes:
injecting the radicals into the two-dimensional material having the layered structure with the reduced interlayer bonding force to form the covalent bond on the surface of the two-dimensional material.

4. The method of claim 1, wherein the ionic material is at least one selected from a group consisting of a lithium ion (Li⁺), a tetraheptylammonium ion (THA⁺), a tetrabutylammonium ion (TBA⁺), and a tetrapentylammonium ion (TPA⁺).

5. The method of claim 1, wherein a material for generating the radicals is 4-nitrophenyl, 4-nitrobenzyldiazonium, or a combination of the 4-nitrophenyl and the 4-nitrobenzyldiazonium.

6. The method of claim 1, wherein the two-dimensional material contains graphene or a transition metal dichalcogenide compound.

7. The method of claim 6, wherein the transition metal of the transition metal dichalcogenide is at least one selected from a group consisting of Mo, W, and In, and the dichalcogen of the transition metal dichalcogenide is S₂, Se₂, or a combination of the S₂ and Se₂.

8. A method for preparing a nanosheet dispersion solution, the method comprising:
a step 1) of adding a two-dimensional material having a layered structure into a solution containing an ionic material and a radical generating material to form a mixture;
a step 2) of applying a voltage to the mixture of the step 1); and
a step 3) of applying an ultrasonic wave to the result of the step 2).

9. The method of claim 8, wherein the ionic material is at least one selected from a group consisting of a lithium ion (Li⁺), a tetraheptylammonium ion (THA⁺), a tetrabutylammonium ion (TBA⁺), and a tetrapentylammonium ion (TPA⁺).

10. The method of claim 8, wherein the radical generating material is 4-nitrophenyl, 4-nitrobenzyldiazonium, or a combination of the 4-nitrophenyl and the 4-nitrobenzyldiazonium.

11. The method of claim 8, wherein the two-dimensional material contains graphene or a transition metal dichalcogenide compound.

12. The method of claim 11, wherein the transition metal of the transition metal dichalcogenide is at least one selected from a group consisting of Mo, W, and In, and the dichalcogen of the transition metal dichalcogenide is S₂, Se₂, or a combination of the S₂ and Se₂.

13. The method of claim 8, wherein the applied voltage is in a range from 10 V to 20 V.

14. The method of claim 8, wherein the ionic material and the radical generating material are contained in the solution in a molar ratio range from 1.5:1 to 4:1.

15. A nanosheet dispersion solution prepared by the method of one of claim 1.
